(19) United States
(12) Patent Application Publication
(10) Pub. No.: US 2017/0259454 A1
(43) Pub. Date: Sep. 14, 2017

(54) LOW-EMITTING FIBER COMPOSITE MANUFACTURING PROCESS

(71) Applicants: John S. Fujii, Vancouver, WA (US); William K. Savage, Yakima, WA (US); Edward Surdyk, Yakima, WA (US)

(72) Inventors: John S. Fujii, Vancouver, WA (US); William K. Savage, Yakima, WA (US); Edward Surdyk, Yakima, WA (US)

(73) Assignee: Neucor Inc., White Swan, WA (US)

(21) Appl. No.: 15/458,892

(22) Filed: Mar. 14, 2017

Related U.S. Application Data
(60) Provisional application No. 62/308,178, filed on Mar. 14, 2016.

(51) Int. Cl. B27N 3/02; B27N 7/00; B27N 3/08

(52) U.S. Cl. CPC B27N 3/02; B27N 3/08; B27N 7/00

(57) ABSTRACT

A novel green manufacturing process for medium and high-density fiberboard (MDF and HDF) production is disclosed, where the green manufacturing process refers to a novel low-emitting manufacture of MDF and HDF in terms of HAP emission. The novel manufacturing process comprises a preconditioning unit operation for raw wood furnish material, where blends comprising two or more woody materials having disparate moisture contents are held in a preconditioning vessel for up to 48 hours under controlled temperature conditions, where the moisture content is homogenized to produce a blend having substantially uniform moisture content. The blend is preconditioned in the novel manufacturing process to facilitate moisture homogenization kinetics, and to uniformly increase the material temperature above the lignin glass transition temperature. Subsequent process steps, such as defibration and fiber drying, require lower temperatures to produce and dry wood fiber, thus lowering HAPs emission.

### CROSS REFERENCE TO PRIORITY APPLICATIONS

This U.S. Non-provisional application claims the benefit of U.S. Provisional Application No. 62/308,178, filed on Mar. 14, 2016.

### FIELD OF THE TECHNOLOGY

This innovation relates to manufacturing processes for medium and high density fiberboard.

### BACKGROUND

Over a decade ago, the U.S. Environmental Protection Agency has promulgated national emission standards for hazardous air pollutants (NESHAPs) governing the plywood and medium- and high-density composite fiber board (MDF and HDF) products industry in the United States. Concomitant establishment of maximum achievable control technology (MACT) standards for NESHAP compliance has prompted the industry to develop “end of pipeline” mitigation technologies and strategies to comply with the NESHAP standards. It has been estimated that for an MDF plant having an annual production of 60,000 MSF (¾ inch basis), such MACT-compliant end-of-pipe emission control engenders capital and operating costs upwards of $1.5 million annually. End-of-pipe emission control may comprise physicochemical methods, such as incineration, and biological processes, such as employment of aerobic or anaerobic microbial digester systems.

Germaine to the composite fiber board industry, hazardous air pollutants (HAPs), which are generally a subset of the volatile organic compounds (VOCs) emitted during fiberboard manufacture, are primarily generated in the production of wood fiber from wood chips, due to high temperatures used at various unit operations in the manufacturing process. Specifically, defibrators, dryers, presses and boilers generate the HAPs in question, and MACT standards have required end-of-pipe equipment on these unit operations. In particular, the fiber preparation unit operation entails a heat treatment process for raw wood chips, wherein pressurized steam is used to heat chips to temperatures above the glass transition temperature of the lignin, so that the woody furnish is softened to the point that cellulosic fibers may be easily separated and isolated to form the composite matt in a refining, or defibration, operation. The state of the art process comprises a pretreatment tube that feeds wood furnish, consisting of several forms of wood material, from both softwood and hardwood species. Typical wood furnish comprises materials with a wide range of particle size, bulk density, and most importantly, moisture content. The range of parameters determines pretreatment process temperatures and time required to uniformly soften the woody material before introduction into the defibration unit.

When exposed to temperatures above 100° C., both hardwoods and softwoods release significant amounts of VOCs. However, different types of VOCs are released from each type of wood, where terpenes are the primary VOCs emitted from relatively moist softwoods at temperatures below 160° C. However, both types of wood have been shown to produce similar volatile compounds that are classified as HAPs, as a result of thermal degradation at higher temperatures. These high temperatures, which range above 130° C., may be typically found in state-of-the-art pretreatment operations that precede fiber refining (defibration) operations, and also during the defibration process per se, in post-refining drying operations, and pressing operations. The HAP compounds in question primarily comprise methanol and formaldehyde, and may also comprise acetone, propanal (acrolein), pentanal and hexanal, amongst others. It has also been shown that the release of HAPs from both types of wood dramatically increase when the moisture content drops below 10% by weight when exposed to temperatures between 130°-160° C. or higher.

Pretreatment or preconditioning of raw wood furnish, typically comprising mixtures of hardwood and softwood shavings, and sawdust particles obtained from lumber and timber operations, where several species of wood are mixed. As a result, these raw wood furnishes typically have an inhomogeneous and disparate moisture content, size distribution and bulk density. Before the disparate wood furnish is subjected to defibration pretreatment, it is conveyed to a steam-pressurized pretreatment tube, wherein the furnish typically has a residence time on the order of 90 seconds. In order to adequately prepare the furnish for defibration refining, the pretreatment tube must be operated at drastic conditions to compensate for the short residence time, where temperatures may be in the range of 170°-200° C., with saturated steam at pressures o 75-130 prig, in order to raise the temperature of the majority of the furnish material above the glass transition temperature of the lignin component to facilitate defibration in the succeeding operation.

Studies have shown that these extreme conditions are severe enough to generate methanol with a residence time of 230 milliseconds in the defibrator unit. Despite the drastic pretreatment conditions, the defibration operation must also rely on intense conditions to maximize fiber separation for subsequent processing. These intense conditions are mostly achieved by injection of pressurized steam at 170°-180° C. in the defibrator unit, with a requisite high energy input in the defibration state to compensate for carry-over non-uniformities. Due to these high processing temperatures, it is in the pretreatment and defibration steps where a significant amount of HAPs are generated and released in the overall fiberboard manufacturing process. In addition, higher mechanical shear is required by the defibrator unit to complete fiber separation of disparate woody materials, resulting in mechanical damage to the fibers, such as fracturing, as well as the creation of short fiber fragments, or fines. Thus the quality of the fiber output is reduced substantially by the harsh conditions (high temperatures and shear) employed in the pretreatment and defibration unit operations.

### SUMMARY OF THE TECHNOLOGY

Embodiments of the innovative technology described herein comprise a novel green process for medium- and high-density fiberboard (MDF and HDF) manufacture, wherein HAPs emission is mitigated. The innovative process introduces a novel low-emitting wood furnish pretreatment step that effectively enables a subsequent ameliorated defibration, or comminution, step that avoids heat-induced degradation of wood components into VOCs and HAPs. As it has been established that the highest level of HAPs released in the defibration (refining) stages in conventional MDF manufacture, is due to compensation for an inefficient and ineffectual pre-treatment stage employed in the current state of the art, the innovative process thus substantially reduces the environmental impact of MDF preparation while at the same time saving on cost. Embodiments of the novel low-emitting MDF and HDF manufacture process require substantially lower process temperatures than the conventional, or current state-of-the-art, methods of MDF and HDF manufacture as practiced by the industry.

According to the innovation, embodiments of the novel low-emitting pretreatment step comprise a novel preconditioning stage, wherein raw wood materials that have disparate particle sizes and moisture contents, are proportionately blended and held in a preconditioning vessel, which, by way of example, may be a chip silo, or a raw material silo, (other types of vessels are considered) for periods of time ranging from 4 hours to 36 hours at ambient or controlled temperatures, in order to 1) homogenize the moisture content of the raw wood furnish proportional blend, wherein the blend has a measured ratio of low- and high-moisture content woody materials, to attain a substantially uniform moisture content ranging between 20-40% by weight, and 2) to introduce said preconditioned raw wood materials into the pre-heater tube of a refining unit operation with minimal additional adjustment of moisture or temperature to bring the wood furnish to a substantially uniform temperature ranging from ambient to 120-160° C., before charging the furnish into refining zone, the latter typically comprises a defibration unit and a pre-heater tube.

In certain embodiments of the novel preconditioning step, a batch of low-moisture content dry woody material, such as wood chips, is directly loaded or charged into the preconditioning vessel, In certain embodiments, water is proportionately metered into the preconditioning vessel in order to prewet the dry woody material by the woody material absorbing the metered water, wherein the amount of metered water is calculated to raise the moisture content of the woody material to a specified level when substantially all of the water is absorbed. Thus the prewetting step of the process results in raising the moisture content of the dry wood material to a level at or exceeding the fiber saturation point of the material after a certain contact time. Typically, the moisture content can be raised from, by way of example, 7-8% to over 50% by weight by this process step. In other embodiments of the innovation, no water is added to the preconditioning vessel.

In all embodiments, a batch of high-moisture content woody material, having a starting moisture content of over 60%, such as green (raw, not dried) sawdust, may be proportionally charged into the preconditioning vessel and blended with the low-moisture content woody material, either prewetted or not, that may be already charged into the preconditioning vessel. The disparate moisture contents of the two woody materials, both the low-moisture content material and the high-moisture content material forming the raw woody blend, are allowed to homogenize the In some embodiments, the final moisture content of the wood furnish after the preconditioning stage is 26-30%. In further embodiments, the final moisture content of the wood furnish is between 30-35%, and in yet further embodiments, the final moisture content of the wood furnish is between 45-40%. All moisture content values are weight percentages, made on an oven-dried wood basis. These values may be measured at the output of the preconditioning stage holding vessel, before transfer to the refining unit operation, or calculated at the input to refining unit operation.

According to the innovation, the novel preconditioning stage temperatures range between ambient and 95° C. The holding times in the novel preconditioning stage range from 20-28 hours in some embodiments, and 12-26 hours in further embodiments. In yet further embodiments, holding times range from 4-48 hours. The holding time depends on kinetics of moisture uptake and uniform distribution by the woody materials.

Once homogenized, the charge is now preconditioned. The preconditioned blended wood furnish is then transferred into a refining unit operation. The latter unit operation comprises a pre-heater tube and a defibration unit. Pressurized steam is injected into the pre-heater tube to heat and soften the preconditioned wood furnish. In some embodiments, the pressurized steam is injected at temperatures ranging between 120°-160° C., and in further embodiments, the pressurized steam is injected at temperatures ranging between 130°-150° C. As a consequence of introduction of preconditioned wood furnish, the high moisture content of the wood furnish prevents formation of HAPs by the pre-heating stage. Moreover, the energy input to the defibration unit operation and production of high quality wood fiber is reduced relative to the energy required in a typical state-of-the-art process. In this respect, lower mechanical shear is needed in the defibration operation, greatly mitigating production of excessively fractured fiber and of short fiber fragments, known as fines, and reducing the mechanical generation of heat incremental to the controlled saturated steam temperature of defibration. The pre-heated wood furnish, regardless of particle size, may be delivered to the defibration unit operation in a condition where the material is at or above its fiber saturation point, and the temperature is within the glass transition, or softening, temperature of the lignin existing in the inter-fiber (interstitial) regions of the wood, wherein the glass transition temperatures typically range between 110° C. and 150° C.

As a further consequence of the uniform moisture content levels and reduced operating temperatures of defibration, the resulting post-refiner/dryer inlet moisture content can be controlled to moderate levels of drying and to low HAP generation conditions in drying and subsequent downstream operations. Most significantly, post-refining fiber drying operations in the innovative manufacture process will require lower temperatures to complete drying since the moisture content has been evened out in the innovative process, without arbitrary addition of water in the pre-heater tube. Total dryer load is reduced and more uniformly controlled by employing the innovative pre-conditioning process, presenting an opportunity for lower drying temperatures and a relatively high final moisture content at the outlet of the dryer (10-15%).

The innovative wood preconditioning step of the innovative manufacture process mitigates the essentially uncontrolled generation of HAPs, which in current state-of-the-art MDF and HDF manufacture processes, is due to the high steam temperatures and non-uniform moisture content of the wood furnish in the refining unit operation. At the same time, the innovative preconditioning step enables the delivery of wet fibers to the dryer inlet of the innovative gentle drying step at a moisture content and uniformity that represents a low total drying load for an innovative dryer that is already designed to dry the fibers without generation of heat-induced HAPs. In conventional wood or wood fiber drying, HAPs emission can be problematic, and the fiber drying unit has been recognized as one of the largest sources of HAPs in MDF and HDF manufacture. The advent of steam-pressurized refining is a more recent addition to state-of-the-art MDF/HDF manufacturing processes, and the role of the defibration process in generating VOC's and HAPs has not been fully elucidated. The innovative MDF manufacturing process disclosed herein elucidates an advance in the current state of art that significantly reduces the generation of emissions from MDF/HDF manufacture while mitigating capital and operating costs for end-of-pipe emission control.

### Definitions

“MDF” and “HDF”. Abbreviations for medium density fiberboard (MDF) and high density fiberboard (HDF) are pressed composite wood fiber panels and other wood structures, generally consisting of wood fiber and adhesive. The use of medium and high densities refer to the degree of compaction, or pressing of fibers to form structures having differing wood content. For the purposes of this disclosure, the term MDF will be used to represent both MDF and HDF manufacture.

“Defibration” and comminution are synonymous for the purpose of this disclosure. These refer to the process of breaking down raw wood materials into wood fiber by separation of wood fibers in the grosser raw materials.

“Glass transition temperature” is the temperature at which non-crystalline solid materials begin to soften structurally. This term is equivalent to softening, and is referred to here as the softening of the raw wood material under heat to facilitate defibration.

“Lignin” is a polymeric material found in all wood. Among other functions, it acts as a glue, holding the cellulosic fibers together in wood, and needs to be softened in order to separate the fibers effectively.

“Furnish” is an industry term referring to a wood material process feed.

“Chip” refers to wood chips, which are substantially larger in size than sawdust and small wood particles.

“Sawdust” refers to small wood particles created in sawing operations, sourced from mills.

“Fiber saturation point” refers to the amount of water required to saturate the cell walls of wood fiber, thereby softening it. For most woods FSP is approximately 26% moisture based on oven dried wood. “Green” wood is typically 60-100% moisture content.

“Moisture content” is the quantity of moisture contained in woody material. It is expressed as percent by weight.

“End-of-pipe” or “end-of-pipeline” refers to the end of a process consisting of a series of process steps, where contaminants and pollutants may be removed from mill effluent prior to discharge into the environment. In this disclosure, end-of-pipe measures to remove HAPs refers to installation of emission control equipment or treatment facilities.

“HAP” is an acronym standing for hazardous air pollutant. The EPA has promulgated many lists pertaining to specific industries. For example, governing the composite wood products industry, the National Emission Standards for Hazardous Air Pollutants (NESHAP) : Plywood and Composite Wood Products, CFR 40 Part 63, embodies the rules related to this.

“VOC” is the abbreviation for volatile organic compound, of which many organic HAPs are classified.

“MACT” is the abbreviation for maximum achievable control technology. MACT standards are destined for HAPs reduction in various industries, and are promulgated by the EPA. These are based on the best-performing sources, i.e., those that have the lowest emission of HAPs within an industry. The emission levels form the basis of a MACT “floor”. A MACT standard must, at a minimum, achieve throughout the industry, a level of emissions control that is at least equivalent to the MACT floor.

### BRIEF DESCRIPTION OF THE DRAWINGS

FIG. 1. Flow chart of a first embodiment of the innovative green MDF manufacturing process.

FIG. 2 Flow chart of the state-of-the-art MDF manufacturing process.

FIG. 3. Flow chart of a second embodiment of the innovative green MDF manufacturing process.

### DETAILED DESCRIPTION

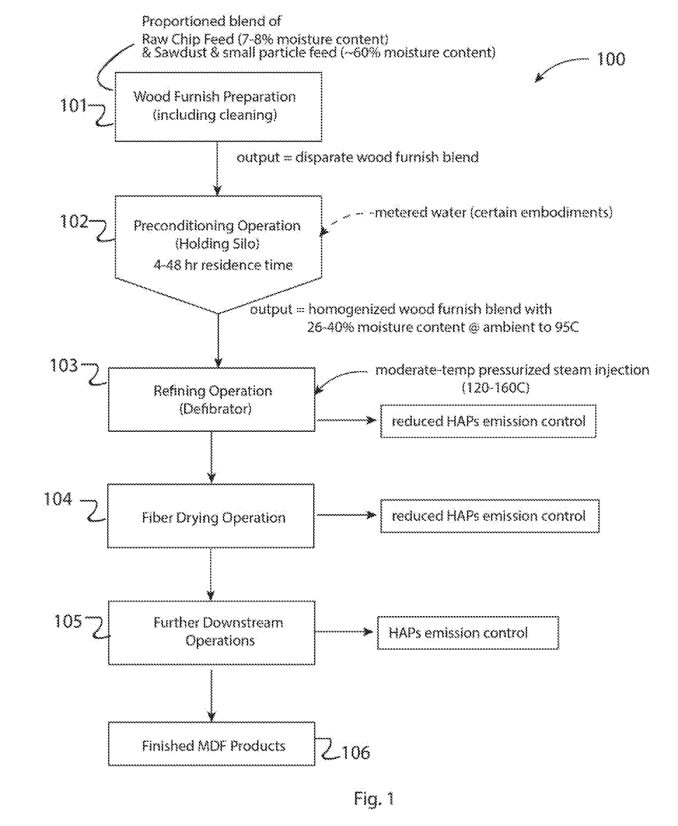

The innovative green (low-emitting) MDF manufacture process is described by the process flow diagram 100 presented in FIG. 1. Beginning with step 101, the wood furnish is prepared by proportionate blending of wood chips and saw dust, which may comprise other small wood particles having sizes between sawdust particles and wood chips. The materials may be sourced from lumber mills, logging operations and other suitable sources, and comprise material from various species of hardwoods and softwoods. Typically, the moisture content varies greatly with the type of material. If the sawdust is green, meaning raw and unprocessed, it may have a moisture content greater than 60% by weight. By contrast, previously kiln dried wood for dimension lumber may have a low moisture content, typically ranging between 7-8%, or generally less than 10%.

As the wood furnish may comprise both sawdust and small wood particles, as well as wood chips and small quantities of bark, the blend is typically inhomogeneous in terms of particle size and moisture content. As the heat capacity of the wood particles is a function of particle size and moisture content, these two characteristics have a strong bearing on the time-dependent temperature rise of the wood particles when subject to high-temperature unit operations as described in the above paragraphs. Thus, particles with high moisture content have a greater heat capacity than those with low moisture content for a given size. Conversely, for a given moisture content, the larger the size of the particle, the larger the heat capacity.

Using the example of the wood furnish blend just described, subjecting such a wood furnish without further conditioning to high temperatures of 160° C. and greater, using pressurized steam, will cause rapid temperature rise in the low moisture content wood chips, promoting thermal degradation as the chips reach pretreatment temperatures. As described above, such thermal degradation generates HAPs for which MACT technology is required. Small particles may not reach such temperatures in the pretreatment operation preceding defibration, but their high moisture content may cause the release of HAPs during downstream drying processes, such as the fiber drying operation carried out after the defibration step, which may use higher temperatures to adequately dry the fibers. As in the state-of-the-art manufacture, the moisture content of fiber output from the defibration operation is substantially disparate, the high dryer temperatures cause further release of HAPs from the dry fibers, and as the wetter fibers dry out, they will rapidly heat to dryer temperatures, which will engender additional HAPs emission.

The proportionate blending comprised by step 101 of the innovative MDF manufacture process allows a homogenized controlled moisture content for the entire wood furnish to be achieved, as the moisture content of the individual components of the blend are known. The total moisture content of the blend may be adjusted to specific ranges by adjusting the composition of the blend, thus the proportional blending. By way of example, in one embodiment, a blend consists of 40% green sawdust, having an average moisture content of 60%, and 60% dry wood chips, having an average moisture content of 7-8%. In step 102 of theinnovative MDF manufacture process of FIG. 1, the wood furnish blend from step 101 has been charged into a holding silo so that the preconditioning operation or stage may be carried out. In this embodiment, the blend may spend up to 48 hours in the holding silo, but not less than 4 hours. In some embodiments, the blend may reside for 20-28 hours; in further embodiments, the holding time may vary between 12-36 hours.

The length of the holding period may be established as the time required for the blend to reach a substantially homogeneous moisture content. This in turn generally depends on the kinetics of water uptake by the woody material comprised by the blend. Temperature is a factor here, and is thus important in determining the rate of uptake of water by the dryer component. Therefore, the operation may be carried out at elevated temperatures in some embodiments, although embodiments in which ambient preconditioning temperatures are employed due to the extended pre-conditioning periods in the innovative process may sufficient to permit water uptake kinetics to complete homogenization of moisture content within 48 hours.

Step 102 induces the water content of the wetter material to be re-distributed to the dryer material, mainly in the form of water vapor uptake, from water evaporation from the wetter material by the high temperatures of the unit operation. In this embodiment, the atmosphere surrounding the wood particles humidifies during the operation as water vapor is released from the wetter, and eventually is absorbed by the dryer material, where the moisture content may rise to levels exceeding 20%, up to 40%, for which the fiber saturation points of the particular wood materials are met or exceeded. The moisture content of the wetter particles may concomitantly decrease to similar levels. Thus, the blend becomes homogenized, wherein the moisture content of the blend components has now become substantially homogeneous. In some embodiments, the preconditioned wood material may undergo further pre-heating stage prior to entry in the refining unit operation to ensure completion of pre-conditioning with respect to temperature and moisture content. Preferred ranges of homogenized moisture content resulting from the innovative MDF manufacture for a wood furnish may range from 26-30% by weight in some embodiments, and 30-35% by weight in further embodiments. In still further embodiments, homogenized moisture content may range from 35-40% by weight.

In other embodiments, water is metered into the preconditioning vessel wherein a batch of dry woody material, such as wood chips, has been precharged. The amount of metered water is calculated to raise the moisture content of the dry material to a specific level when the water is substantially absorbed by the dry material. The contact time with the metered water depends on the uptake kinetics that depends the temperature, which may be raised above ambient in some embodiments.

In step 103, the transferred pretreated wood furnish is defibrated in the fiber refining operation. In this step, pressurized steam is injected into the defibration unit at temperatures ranging from 120°-160° C. In comparison with state-of-the-art MDF manufacture, the steam temperatures needed in the innovative MDF process are relatively moderate, as discussed below, due to the innovative preconditioning step, step 102. Due to step 102, refining conditions are less extreme in the innovative MDF manufacture process as compared to the state-of-the-art MDF manufacture processes currently widely practiced. As a result of the lower steam temperatures injected into the defibration unit, generation of HAPs is minimized, as steam temperatures remain below 160° C., above which HAPs release is greatly augmented. In some embodiments, temperature of the pressurized steam injected into the defibration unit operation is 130° C., while in other embodiments, pressurized steam temperatures used in step 103 may range between 120°-150° C. In all embodiments, the temperature of the pressurized steam injected at step 103 may fall between 100°-160° C. As indicated in FIG. 1, emission control requirements to cap HAPs evolved in step 103 are concomitantly reduced, saving capital and operational costs and expenses. An estimated cost savings may be $1.5 million per year for an MDF plant of 60,000 msf/year capacity—¾″ basis, a typical size for modern MDF plant. Energy input requirements for the unit operation embodied in step 103 are also substantially reduced.

As the preconditioned wood furnish is delivered to the refining unit operation 103 above the lignin glass transition temperature, leaving the wood material in a softened state, fibers are more easily separated than is the case in the state-of-the-art process. In the latter process, the wood furnish is not uniformly heated and softened in the short time spent in the pretreatment unit operation (see discussion below). Mechanical shear requirements to achieve a clean separation of fiber are thus necessarily lower in the innovative MDF process in comparison to the state-of-the-art MDF manufacture. As a result, the quality of the fiber produced in the defibration step is generally higher than in the state-of-the-art manufacture, as fiber fracture and production of short fragments (fines) is minimized.

Moreover, the innovative preconditioning step 102 prepares the wood furnish with a substantially uniform and an overall lower moisture content relative to state-of-the-art MDF manufacture, thus the moisture content of the refined fiber issuing from defibration step 103 is also substantially uniform. As a result, lower fiber dryer outlet temperatures, 55°-60° C. typical in most embodiments, are needed in the subsequent drying step 104, minimizing HAPs release in this step. In conventional state-of-the-art MDF (and HDF) manufacture, the fiber drying unit operation has also been identified as a source of HAPs. In the innovative process, HAP production in step 104 is minimized due to the lower drying temperatures required as a result of steps 102 and 103.

Emission controls requirements for HAPs production in step 104 are concomitantly reduced as well, indicated in FIG. 1, again reducing energy consumption and saving capital and operational expenses, as described in the above paragraphs. The lower temperature range at the outlet of the dryer in the innovative process prepares the wood fibers to a moisture content in the range 10-15% moisture based on oven-dried wood. The generation of HAPS at much higher temperatures (>130° C.) is negligible until the moisture content is lowered to 5-8%. The temperature effect does not become critical until the moisture content is reduced below approximately 26%-10% (depending on wood species) because of the evaporative cooling effect of drying.

Subsequent to step 104 are the remaining unit operations to complete manufacture of the MDF and HDF products. These comprise, among others, fiber mat forming, pre-pressing, trimming, hot pressing, cooling, sawing, sanding and trimming, painting or laminating, and packaging, all of which are embodied in step 105, leading to the finished product in step 106. In some embodiments, step 105 in the innovative process may be substantially the same as in conventional MDF and HDF manufacture, and HAPs that may be produced in these operations are not significant as temperatures used for the remaining production are generally substantially lower than 160° C., and the residual HAP content of previously kiln-dried wood materials is significantly lower than never-dried wood.

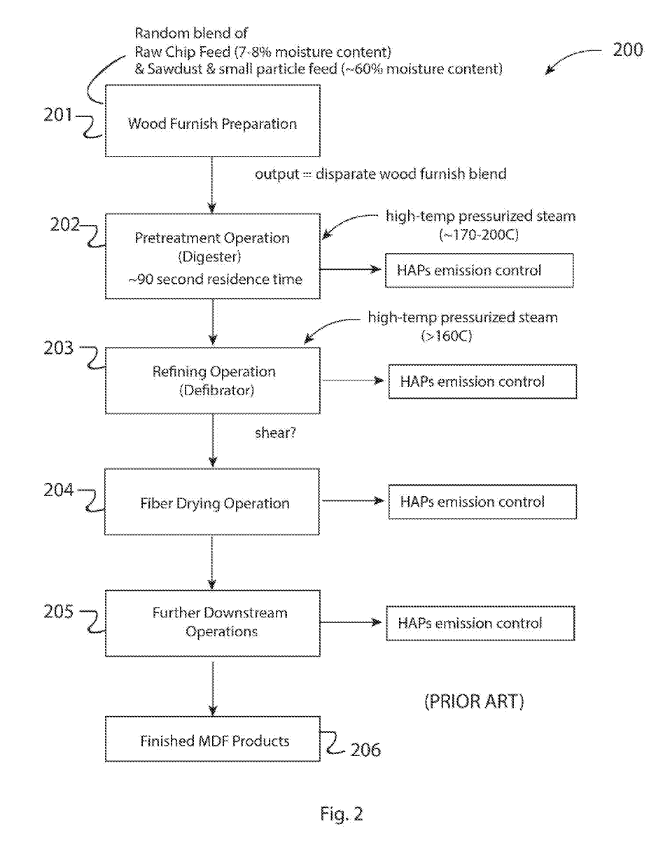

For comparison, a conventional MDF (and HDF) manufacture process flow chart 200 is shown in FIG. 2. In step 201, a wood furnish is prepared by random blending of sawdust and small particle wood material with larger wood chips. Again, these materials may be sourced from lumber mills and logging operations, and may comprise several species of hardwoods and softwoods. The moisture content of the woody materials is disparate, as the sawdust may be substantially wetter than the chips, as indicated in FIG. 2. The disparate wood blend is delivered to the pretreatment operation in step 202. However, as discussed above, the residence time within the pretreatment unit operation is typically 90seconds, necessitating high temperatures for the pretreatment, where pressurized steam is injected at temperatures between 170°-200° C. to pre-heat and soften the woody material.

At these temperatures, significant thermal degradation of the wood furnish may occur, releasing a large quantity of HAPs. Even under these conditions, a uniform attainment of lignin glass transition in the wood is not achieved for softening, and conditions in the following defibration operation (step 203) are of necessity also extreme to effect efficient fiber separation. As the temperature of a large portion of the woody material is not in the lignin glass transition temperature range, this portion of the woody material is brittle and resistant to clean fiber separation. In step 203, high shear is often required to obtain sufficient fiber separation.

The high shear creates a large degree of fractured fibers and production of fines, resulting in a lower quality fiber mass. In an attempt to ameliorate this situation, pressurized steam is injected into the defibration unit at high temperatures, typically over 160° C., to adequately soften the woody material that was not adequately heated in pretreatment step 202. Here, the HAPs emission is severe due to extensive thermal degradation. The large HAPs release in both steps 202 and 203 due to the high temperature has been found to be the largest source of HAPs in the entire MDF and HDF manufacturing chain. NESHAPs requirements necessitate substantial MACT-compliant emission control in order to contain the pollutants, engendering significant capital and operating costs. In addition, energy costs are significant as well, as the energy input is high.

This scenario is contrasted with the cost savings of the greener innovative MDF/HDF manufacturing process shown in FIG. 1, and discussed above. As a further point, fibers discharged from the defibration operation in step 203 have a disparate moisture content, since the moisture content of the overall wood furnish was not homogenized. Thus, drying in step 204 typically requires higher temperatures in comparison to the innovative process at both the inlet and outlet points of the indirectly heated dryer. For conventional MDF/HDF manufacture processes, such as that indicated in FIG. 2, dryer inlet temperatures can be at 140-150° C. (280°-300° F.) and 65-68° C. (150°-155° F.) at the outlet. In embodiments of the instant process, the inlet temperatures are lower, ranging from 130°-140° C. (265°-285° F.) and 55°-60° C. (130°-140° F.) at the outlet. Both temperature ranges are governed by the drying load.

The instant innovation reduces that load to a range wherein the lower and more moderate temperature ranges indicated may be employed to remove the moisture from the wetter fibers in the wood furnish blend. In embodiments of the novel process, the exit moisture content may be controlled to 10-15% based on oven-dried wood. At these moisture content levels, HAPs generation is greatly suppressed as the wood temperature remains below critical temperatures where HAPs generation begins. Again, high temperatures in the drying operation engender significant HAPs release as well, with consequential MACT compliant emission control. Secondarily, energy input requirements for fiber drying step 204 are higher than for the same stage in the innovative MDF manufacture process (step 104 in FIG. 1).

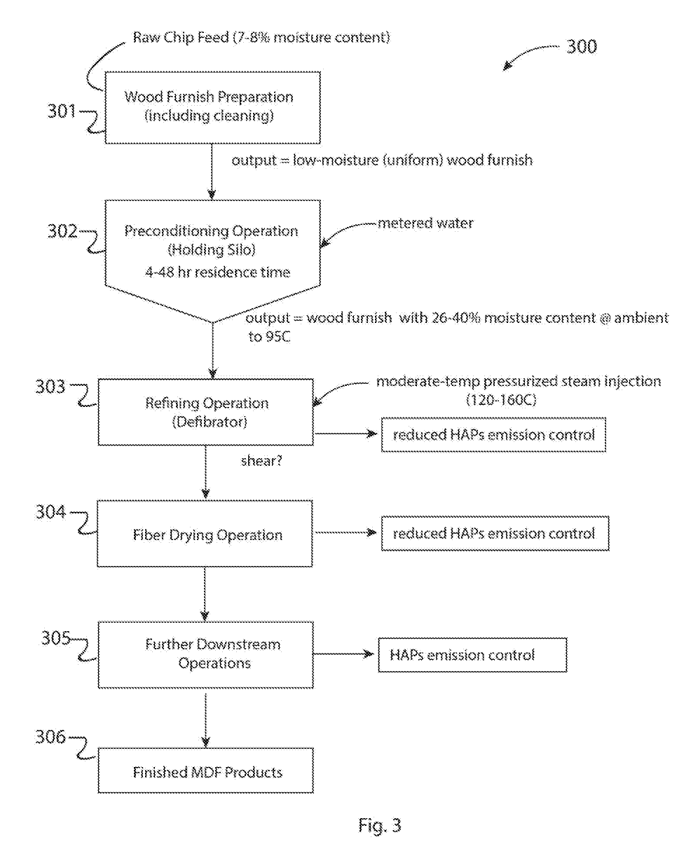

As a further embodiment of the innovative green MDF (and HDF) manufacture process, an example modified process flow chart 300 is shown in FIG. 3. An exemplary wood furnish comprising low-moisture content woody material, having 7-8% moisture content, is introduced in step 301. In some cases, a relatively dry wood furnish may be available as a woody feed stock, such as dry wood shavings or chips. In step 302, a preconditioning unit operation is embodied, where a holding silo is charged with the wood furnish. As in FIG. 1, the holding times may range from 4-48hours, depending on the moisture uptake kinetics of the type of wood material.

Contrasting with the earlier embodiment of the innovative manufacture shown in FIG. 1, in this embodiment water is metered into the holding unit in proportion to the amount of wood furnish contained in the holding unit (vessel or silo). The quantity of water metered into the unit is to be absorbed by the woody material, and is calculated to bring the moisture content to a minimum of 26%, ranging up to 40% when absorbed. The operation may be performed at elevated temperatures, such as those described for the earlier embodiment (FIG. 1). Typical temperatures for this operation may range from ambient to 95° C. Following the modified preconditioning step (302), steps 303-306 are the same as steps 103-106 in FIG. 1.

### Example Process

A proportionally blended feed stock furnish consisting of green (unprocessed) sawdust having a 60% moisture content is blended in a 40:60 ratio (respectively) with dry planar shavings having a moisture content of 7-8%, representing a typical disparate raw material blend. The moisture conditions cannot be efficiently mitigated in a conventional pretreatment tube, without using extreme conditions that engender high emission of HAPs and VOCs.

The disparate furnish is introduced into a chip silo for a holding period of 28hours, and permitted to re-distribute the moisture content from the wetter material to the dryer material. The final moisture content of the blend is thus homogenized to 29% after 28hours. The homogenized furnish in transferred to the refining, or defibration unit operation, where it is subject to pressurized steam injected at 120° C. High quality fiber output from the defibrator unit is transferred to the fiber drying unit operation, and dried at 60° C.

The embodiments described herein constitute several examples of the novel green MDF manufacturing process, and are by no means to be construed as limiting the innovation to these examples. Skilled practitioners of the art will recognize that the innovation may be manifest in a multitude of equivalent variations, and when practiced do not depart from the scope and spirit of the innovation, as claimed in the claims that follow.

1. A low VOC- and HAP-emitting medium- and high-density fiberboard manufacturing process, comprising the steps of:
(i) loading into a preconditioning vessel a batch of a raw wood furnish blend, comprising a proportional blend of high-moisture content wood particles and low-moisture content wood particles, wherein the total moisture content of the raw wood furnish blend is substantially equal to the proportional sum of the water content of the high-moisture content wood particles and the low-moisture content wood particles;
(ii) preconditioning the raw wood furnish blend in the preconditioning vessel, wherein the raw wood furnish is held for up to 48 hours, wherein the moisture content of the raw wood furnish is substantially homogenized;
(iii) refining the preconditioned wood furnish preconditioned in the preceding step, wherein pressurized steam is injected into the refining unit at steam temperatures of 160° C. or less, and wherein wood fiber is discharged from the refining unit; and
(iv) drying the wood fiber discharged from the refining unit, wherein the inlet temperature of the drying unit is 140° C. or less, and the outlet temperature of the drying unit is 60° C. or less.

2. The low VOC- and HAP-emitting medium- and high-density fiberboard manufacturing process of claim 1, wherein the step of preconditioning the raw wood furnish blend comprises metering of water into the preconditioning vessel onto the blended.

3. The low VOC- and HAP-emitting medium- and high-density fiberboard manufacturing process of claim 1, wherein the step of loading into a preconditioning vessel a raw wood furnish blend comprises prewetting the low-moisture content wood particles, wherein water is metered onto a batch of said low moisture-content wood particles (and an equilibration time is allowed to ensue), then loading the batch of prewetted low-moisture-content wood particles into the preconditioning vessel to form the raw wood furnish blend with the high-moisture content wood particles.

4. The low VOC- and HAP-emitting medium- and high-density fiberboard manufacturing process of claim 1, wherein the step of preconditioning the raw wood furnish blend in a preconditioning vessel comprises preconditioning the raw wood furnish between 12 hours and 36 hours at temperatures ranging between ambient and 95° C.

5. The low VOC- and HAP-emitting medium- and high-density fiberboard manufacturing process of claim 1, wherein the step of preconditioning the raw wood furnish blend in a preconditioning vessel comprises homogenizing the moisture content of the raw wood furnish blend to at least 20% by weight.

6. The low VOC- and HAP-emitting medium- and high-density fiberboard manufacturing process of claim 1, wherein the step of preconditioning the raw wood furnish blend in a preconditioning vessel comprises homogenizing the moisture content of the raw wood furnish blend to levels ranging between 26% and 30% by weight.

7. The low VOC- and HAP-emitting medium- and high-density fiberboard manufacturing process of claim 1, wherein the step of preconditioning the raw wood furnish blend in a preconditioning vessel comprises homogenizing the moisture content of the raw wood furnish blend to levels ranging between 35% and 40% by weight.

8. The low VOC- and HAP-emitting medium- and high-density fiberboard manufacturing process of claim 1, wherein the step of drying the wood fiber discharged from the drying unit comprises drying the wood fiber wherein exit moisture content ranges between 10% and 15% by weight based on oven dried wood.

9. A manufacturing system for a low VOC- and HAP-emitting medium- and high-density fiberboard manufacturing process, comprising:
(i) A preconditioning vessel for preconditioning a raw wood furnish blend, said raw wood furnish blend comprising a proportioned mixture of high-moisture content wood particles and low-moisture content wood particles, the preconditioning vessel adapted to hold the raw wood furnish blend for up to 48hours;
(ii) a refining unit operation comprising a defibrator, the refining unit adapted to receive pressurized steam, wherein the pressurized steam is injected at temperatures ranging up to 160° C., said refining unit further adapted to receive discharged preconditioned wood furnish blend from the preconditioning vessel; and
(iii) a fiber drying unit operation comprising a fiber dryer, the fiber dryer having inlet temperatures of 140° C. of less, and exit temperatures of 60° C. or less, the fiber drying unit operation adapted to receive fiber discharged from the refining unit operation.

10. The manufacturing system for a low VOC- and HAP-emitting medium- and high-density fiberboard manufacturing process of claim 9, wherein the fiber dryer has an inlet temperature range of 130° C. to 140° C., and an exit temperature range of 55° C. to 60° C.

11. The manufacturing system for a low VOC- and HAP-emitting medium- and high-density fiberboard manufacturing process of claim 9, wherein the preconditioning vessel is adapted to hold the raw wood furnish blend for residence times ranging between 12 hours and 36 hours.

12. The manufacturing system for a low VOC- and HAP-emitting medium- and high-density fiberboard manufacturing process of claim 9, wherein the preconditioning vessel is adapted to homogenize the moisture content of the raw wood furnish blend to moisture levels ranging between 20% and 40% by weight.

13. The manufacturing system for a low VOC- and HAP-emitting medium- and high-density fiberboard manufacturing process of claim 9, wherein the preconditioning vessel is adapted to homogenize the moisture content of the raw wood furnish blend to moisture levels ranging between 26% and 30% by weight.

14. The manufacturing system for a low VOC- and HAP-emitting medium- and high-density fiberboard manufacturing process of claim 9, wherein the preconditioning vessel is adapted to homogenize the moisture content of the raw wood furnish blend to moisture levels ranging between 30% and 35% by weight.

15. The manufacturing system for a low VOC- and HAP-emitting medium- and high-density fiberboard manufacturing process of claim 9, wherein the preconditioning vessel is adapted to receive pressurized steam injected at temperatures up to 140° C.

16. The manufacturing system for a low VOC- and HAP-emitting medium- and high-density fiberboard manufacturing process of claim 9, wherein the preconditioning vessel is adapted to hold the raw wood furnish between 12 hours and 36 hours at temperatures ranging from ambient to 95° C.

17. The manufacturing system for a low VOC- and HAP-emitting medium- and high-density fiberboard manufacturing process of claim 9, wherein the drying unit operation is adapted to dry the discharged fiber to a moisture content ranging between 10% and 15% by weight based on oven dried wood.
